(19) United States
(12) Patent Application Publication
(10) Pub. No.: US 2016/0000136 A1
(43) Pub. Date: Jan. 7, 2016

(54) Juice Extractor

(71) Applicant: Hamilton Beach Brands, Inc., Glen Allen, VA (US)

(72) Inventor: Matthew T. Carley, Richmond, VA (US)

(21) Appl. No.: 14/755,598

(22) Filed: Jun. 30, 2015

Related U.S. Application Data
(60) Provisional application No. 62/019,941, filed on Jul. 2, 2014.

(51) Int. Cl. A23N 1/02

(52) U.S. Cl. CPC A23N 1/02

(57) ABSTRACT

A juice extractor includes a housing, a lid for covering the housing and enclosing an interior thereof and a generally cylindrical food chute projecting into the housing through the lid. The chute defines an unrestricted interior channel from an open upper end thereof to an open base end thereof for receiving and passing foodstuff therethrough. The chute has an internal diameter of approximately three and a half inches and a length from the upper end to the base end of at least approximately eight inches. A food pusher is slidably receivable within the interior channel of the chute and is movable between a disengaged position, wherein the food pusher is not engaged with the chute and the interior channel remains unrestricted and continuously open between the upper end and the base end, and an engaged position, wherein the food pusher is slidably received within the interior channel of the chute.

### CROSS-REFERENCE TO RELATED APPLICATIONS

This application claims priority to U.S. Provisional Patent Application No. 62/019,941, filed on Jul. 2, 2014, entitled “Juice Extractor,” the entire contents of which are incorporated by reference herein.

### FIELD OF THE DISCLOSURE

The present disclosure is generally directed to a juice extractor, and, more particularly, to a juice extractor having a large food chute to facilitate the passage of larger foodstuff therethrough but that does not contain an interlock mechanism in the food chute.

### BACKGROUND

Juice extractors are generally known in the small appliance art. Typically, juice extractors have food chutes that are no greater than 3″ in diameter and no less than 4″ in length, in order to comply with the Underwriters Laboratories (“UL”) safety standard requirements and suitably protect a consumer. The UL standard requires such combination of dimensions because it has found that the combination of a 3″ diameter and a 4″ length will generally prevent an average adult's hand from extending far enough into the food chute to contact the grating blade, which would otherwise result in potentially serious injury.

However, one drawback of such relatively small sized food chutes is the limitation of use of the juice extractor to smaller diameter foodstuff or to passing the foodstuff through the food chute in a limited quantity. When using a juice extractor having such a food chute, if a user wishes to extract juice from a relatively larger foodstuff, e.g., an apple, the user must first chop the larger foodstuff into smaller pieces sized to fit through the chute. This process can be particularly cumbersome and time-consuming, especially when the user wishes to produce a larger amount of juice. The diameter of a conventional food chute restricts the number of food items or overall volume of food that can be introduced at one time.

To address this drawback, some juice extractors have food chutes that are larger than 3″ in diameter. However, for UL Listing, such food chutes must be provided with either an electrical or mechanical barrier, or some combination thereof, to prevent operation of the juice extractor without the presence of a food pusher engaged within the food chute. Such configurations may include a physical barrier therein, e.g., a trap door, that blocks access to the blade and is released when physically engaged by the food pusher, and thus aids in preventing a user's fingers from contacting the grating blade. Foodstuff advanced through a food chute having a barrier must bias the barrier into an open position, unblocking access to the grating blade, in order to access the blade.

Such barrier structures are not without drawbacks, however. For example, the presence of a barrier limits the length and amount of foodstuff that can be added to the food chute and also requires a user to use greater force to push foodstuff through the food chute in order to move the barrier into the open position. Further, the barrier structure often poses cleaning challenges due to the increase in parts and thus the increase in locations for food to get stuck. Yet further, as the barrier structure is an additional movable operating part, juice extractors having such a barrier structure generally make more noise and/or vibrations during operation than juice extractors without such barrier structures and are potentially more susceptible to breakage and/or malfunction. These drawbacks can also be cumbersome for users.

Therefore, it would be desirable to provide a juice extractor having a relatively large food chute, in excess of a 3″ diameter, that does not include a barrier or other interlock mechanism associated therewith or therein without subjecting users to a greater risk of injury.

### BRIEF SUMMARY OF THE DISCLOSURE

Briefly stated, one aspect of the present disclosure is directed to a juice extractor including a housing and a lid for covering the housing and enclosing an interior thereof. A generally cylindrical food chute projects into the housing through the lid. The food chute defines an unrestricted interior channel from an open upper end thereof to an open base end thereof for receiving and passing foodstuff therethrough, and defines an internal diameter of approximately three and a half inches and a length from the open upper end to the open base end of at least approximately eight inches. The food chute does not contain a interlock mechanism associated therewith or therein. A rotatable grating disk proximate the base end of the food chute is rotatable about a substantially vertical axis for grinding the foodstuff advanced through the food chute. A filter surrounds an outer periphery of the grating disk for permitting juice extracted from the foodstuff to flow therethrough, and retaining a remainder of the foodstuff. A food pusher is slidably receivable within the interior channel of the food chute and is movable between a disengaged position, wherein the food pusher is not engaged with the food chute and the interior channel remains unrestricted and continuously open between the open upper end and the open base end, and an engaged position, wherein the food pusher is slidably received within the interior channel.

### BRIEF DESCRIPTION OF THE DRAWINGS

The following detailed description of a preferred embodiment of the disclosure will be better understood when read in conjunction with the appended drawings. It should be understood, however, that the disclosure is not limited to the precise arrangements and instrumentalities shown. In the drawings:

FIG. 1 is a front and side perspective view of a juice extractor, according to a preferred embodiment of the disclosure;

FIG. 2 is an exploded front and side perspective view of the juice extractor of FIG. 1;

FIG. 3 is a cross-sectional perspective view of the juice extractor of FIG. 1, taken along the sectional line 3-3 of FIG. 1; and

FIG. 4 is a top plan view of the juice extractor of FIG. 1.

### DETAILED DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the juice extractor, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

It should also be understood that the terms “about,” “approximately,” “generally,” “substantially” and like terms, used herein when referring to a dimension or characteristic of a component of the disclosure, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

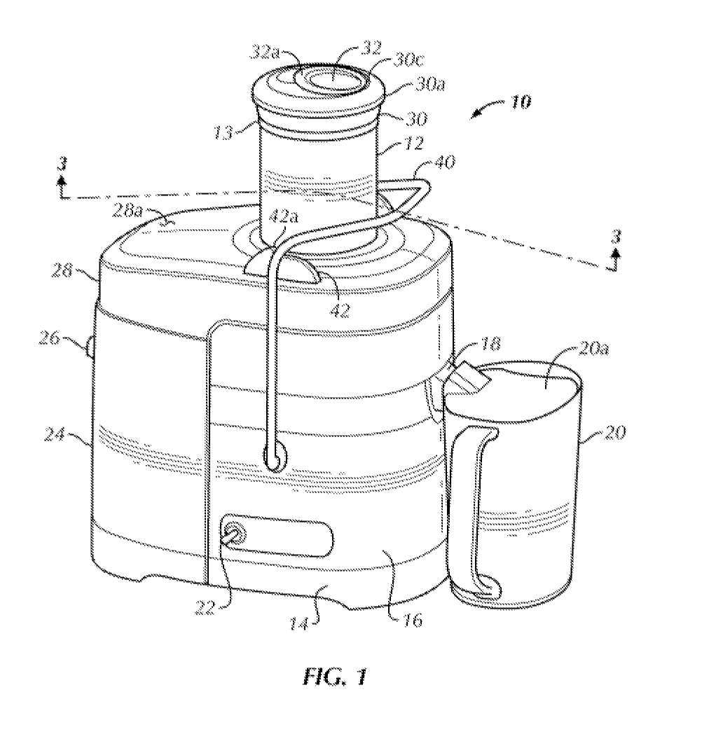

Referring to the drawings in detail, wherein like numerals indicate like elements throughout, there is shown in FIGS. 1-4 a juice extractor, generally designated 10, in accordance with the present disclosure. The juice extractor 10 of the present disclosure preferably includes a relatively large food chute 12 to allow the passage of multiple and/or larger foodstuffs (not shown) therethrough, without any barrier structure therein, as described in greater detail below.

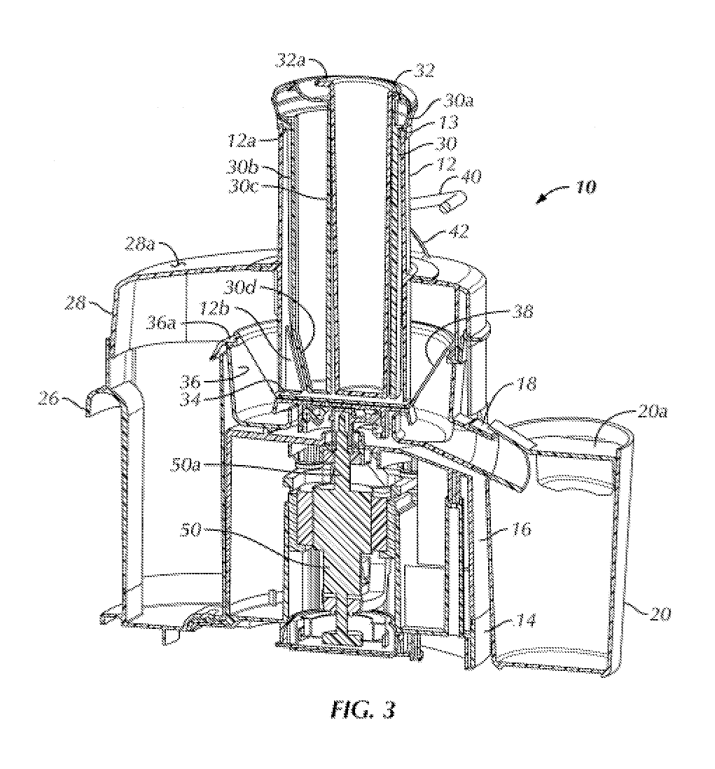

As shown, the juice extractor 10 includes a motor housing 14 and an upper housing 16 mounted atop the motor housing 14 and surrounding at least a portion of the motor housing 14 (see FIG. 3). As also shown in FIG. 3 the upper housing 16 includes an open top end. The motor housing 14 preferably contains electrical components (not shown) and drive components (FIG. 3) of the juice extractor 10. In one embodiment, the upper housing 16 may be wrapped in stainless steel. The upper housing 16 supports and positions a juice bowl 36 therein as will be described further below. The juice bowl 36 includes an integral spout 18 extending generally downwardly therefrom, through which juice (not shown) extracted from foodstuff within the juice extractor 10 flows. The spout 18 is generally oriented such that a pitcher 20 (optionally having cover 20a) or other container can be placed underneath the lower end of the spout 18 to enable the juice to be collected therein.

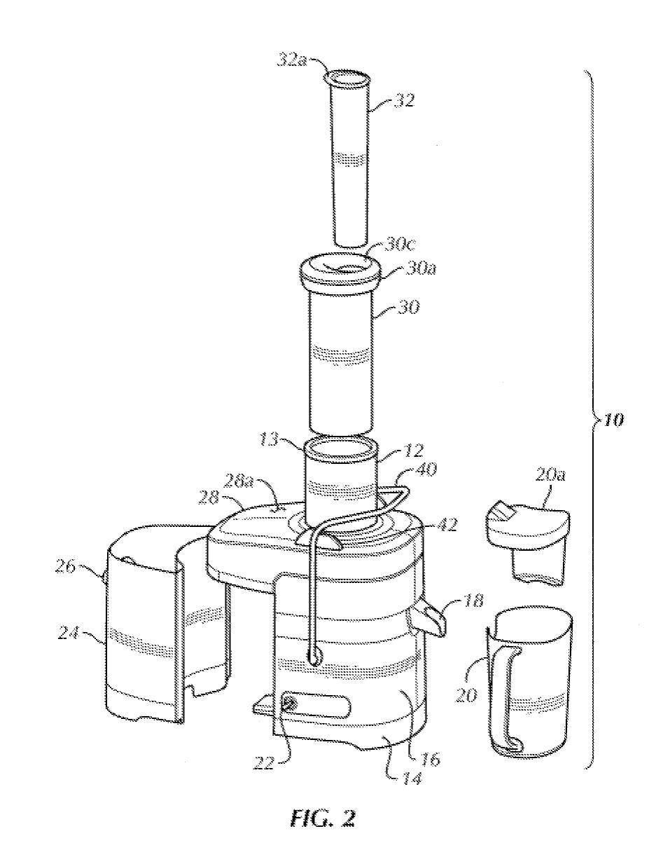

As shown in FIGS. 1 and 2, a switch 22 is positioned on a front face of the upper housing 16 to allow a user to activate the juice extractor 10. In one embodiment, the switch 22 is a toggle switch, movable between a high speed setting position, e.g., for harder foodstuff, an opposing low speed setting position, e.g., for softer foodstuff, and an intermediate OFF position. However, as should be understood by those of ordinary skill in the art, the juice extractor 10 could have more than one switch, or a different switch, e.g., a switch pivotable solely between an OFF position and an ON position, a rotary knob to allow for the multiple settings, or the like.

The assembled juice extractor 10 includes a generally hollow pulp bin 24, having an open top, removably attached thereto, preferably proximate the upper housing 16 and the motor housing 14, for the collection of pulp and other foodstuff byproducts of the juicing process, as will be described in greater detail below. As shown best in FIG. 3, the pulp bin 24 includes a graspable handle 26 on a lateral side surface thereof. In the illustrated embodiment, the handle 26 extends laterally away from the pulp bin 24 to allow a user to grip the handle 26 thereby and slidably withdraw the pulp bin 24 laterally away from the juice extractor 10, or slidably insert the pulp bin 24 into assembly with the juice extractor 10. Thus, via the handle 26, a user can relatively quickly and easily remove the pulp bin 24, e.g., to empty the pulp bin 24 of pulp and/or other foodstuff byproducts and then replace the pulp bin 24 to continue usage of the juice extractor 10. As should be understood by those of ordinary skill in the art, however, the pulp bin 24 may alternatively include a handle 26 at a different location and/or of a different shape or configuration than the handle 26, provided the handle allows a user to withdraw and insert the pulp bin 24 as described herein. Further alternatively, it is contemplated that the pulp bin 24 has no handle at all.

Referring now to FIG. 3, a lid 28 is located atop the upper housing 16 (including the juice bowl 36) and the pulp bin 24 to generally enclose an interior of the juice extractor 10. The lid 28 includes the generally cylindrical food chute 12 extending from and through a top surface 28a thereof. In the illustrated embodiment, the food chute 12 extends generally perpendicularly to the top surface 28a of the lid 28 and extends both upwardly and downwardly from the top surface 28a, such that the food chute 12 extends into juice bowl 36. While it is preferred that the food chute 12 be generally cylindrical and perpendicular with respect to the top surface 28a of the lid 28, it is within the spirit and scope of the present disclosure that the food chute 12 be shaped differently or be disposed at a different orientation with respect to the top surface 28a, provided that the food chute 12 is capable of functioning in the manner described herein.

In a preferred embodiment, the food chute 12 is approximately three and a half inches in inner diameter, thereby enabling multiple foodstuffs and/or larger foodstuffs to be inserted therein and pass therethrough at one time. The food chute 12 is approximately at least eight inches in length, i.e., from the top of the food chute 12 to a grating disk 34 (described further below) adjacent an opposing bottom end of the food chute 12. Such a large dimension would generally require an interlock assembly associated with the food chute. However, it was discovered that these dimensions could be safely provided for the first time in an extractor/processor. Therefore, the food chute is not associated with any interlock mechanism. There is a switch associated with a rotatable member, but the switch is not connected to an interlock mechanism or switch in the food chute. The grating disk 34 has a diameter at least substantially equal to, or slightly larger than, the outer diameter of the base end of the food chute 12, and the axial center of the food chute 12 is generally in registry with the axial center of the grating disk 34.

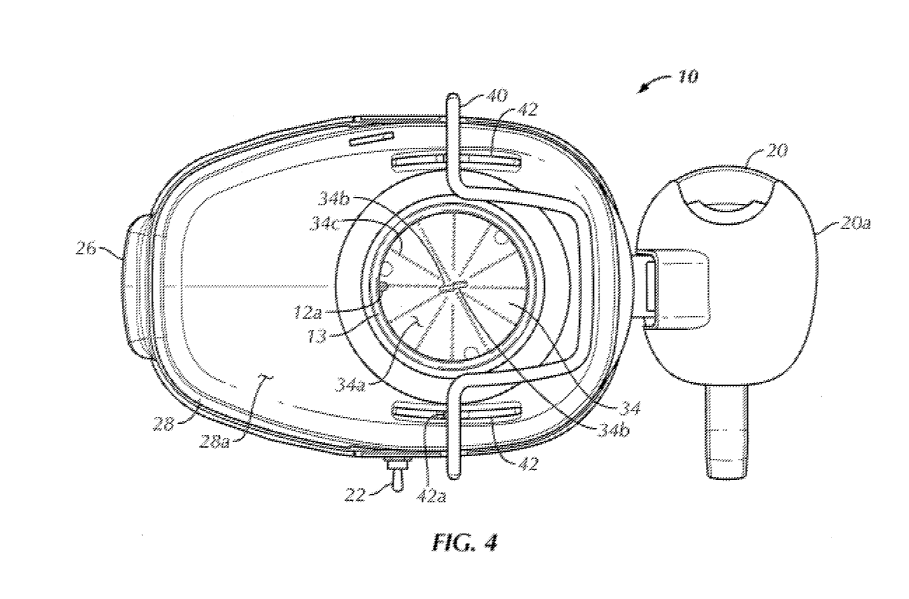

As shown best in FIGS. 3 and 4, a ring 13 is mounted atop a top end of the food chute 12 and also defines, in a preferred embodiment, an inner diameter of approximately three and a half inches. The ring 13 includes a tab 12a extending radially inwardly from an inside surface thereof. The tab 12a functions to align a first food pusher 30 with an integral wedge projection 12b at the bottom of the food chute 12 and also to inhibit rotation of the first food pusher 30 within the food chute 12 during operation of the juice extractor 10, as will be described in greater detail below. As should be understood by those of ordinary skill in the art, however, the tab 12a may alternatively be integral to the food chute 12 and extend radially inwardly therefrom. It is also within the spirit and scope of the present disclosure that more than one tab (not shown) may be included in the ring 13 or the food chute 12 or that the tab 12a extends as a rib along at least part of the inner surface of the food chute 12.

As shown best in FIG. 3, a generally cylindrical first food pusher 30 is preferably freely insertable into the food chute 12 for the selective urging of foodstuff down the food chute 12. The first food pusher 30 is preferably easily removable from within the food chute 12 in order to allow the user to insert foodstuff into the food chute 12 during use of the juice extractor 10. The first food pusher 30 is generally shaped to fit within the food chute 12 with minimal clearance between the first food pusher 30 and the inner wall of the food chute 12. As shown, the first food pusher 30 includes a slightly radially larger top end 30a to prevent the food pusher 30 from slipping entirely into the food chute 12. The radially larger end 30a also acts as a handle for easier grasping of the first food pusher 30.

The first food pusher 30 further includes a slot 30b extending in the axial direction and projecting radially inwardly for accommodating the tab 12a of the ring 13 or the food chute 12. The slot 30b is in sliding engagement with the tab 12a when the first food pusher 30 is inserted into the food chute 12. The base end of the food chute 12 includes the wedge projection 12b projecting radially inwardly along a portion of the inner circumference of the food chute 12 to assist in preventing free movement of the foodstuff within the food chute 12. The first food pusher 30 includes a tapered portion 30d, complementary to the wedge projection 12b when the first food pusher 30 is properly aligned with the food chute 12 via engagement of the slot 30b with the tab 12a. The distal end of the food pusher 30 opposite the larger end 30a preferably includes a plurality of small protrusions (not shown) projecting slightly axially therefrom in order to enhance the grip of the first food pusher 30 with the foodstuff. The small protrusions grip on to the foodstuff when the first food pusher 30 urges the foodstuff down the food chute 12. The small protrusions also help to prevent independent rotation of the foodstuff relative to the first food pusher 30 and the tab 12a prevents the food pusher 30 from rotating within the food chute 12.

As shown best in FIG. 3, the first food pusher 30 includes a generally cylindrical bore 30c extending therethrough for receiving a second, smaller food pusher 32 therein. Similarly to the first food pusher 30, the generally cylinder second food pusher 32 is preferably freely insertable into the first food pusher 30. Accordingly, for smaller foodstuff, a user may insert the smaller foodstuff into the bore 30c during use of the juice extractor 10, rather than the food chute 12, urge the smaller foodstuff down the bore 30c via the second food pusher 32. The second food pusher 32 is generally shaped to complimentarily fit within the bore 30c with minimal clearance between the second food pusher 32 and the inner wall of the bore 30c. The second food pusher 32 includes a slightly radially larger top end 32a to prevent the second food pusher 32 from slipping entirely into the first food pusher 30 and to act as a handle for easier grasping of the second food pusher 32.

As also shown in FIG. 3, the upper housing 16 supports the juice bowl 36 therein. In the illustrated embodiment, an upper flange 36a of the juice bowl rests atop a top edge of the upper housing 15. However, as should be understood by those of ordinary skill in the art, the juice bowl 36 may be supported within the upper housing 16 via other known means. The juice bowl 36 is provided with an integral projection (not shown) on a bottom portion thereof that engages a complementary projection of the upper housing 16 (not shown) to axially align the juice bowl 36 with the motor shaft 50a (described below) and prevent rotation of the juice bowl 35. The juice bowl 36 functions to help direct pulp and other foodstuff byproducts into the pulp bin 24 and help inhibit pulp and foodstuff byproducts from entering into the interior of the upper housing 16 and potentially flowing through the spout 18 with the juice or clogging the spout 18.

The grating disk 34, within the juice bowl 36, is rotatable about a substantially vertical axis. A frustoconically shaped filter 38, also within the juice bowl 36, is attached to the outer periphery of the grating disk 34. The filter 38 projects upwardly and outwardly from the grating disk 34. The food chute 12, arranged above the grating disc 34, extends into the juice bowl 36 to the grating disk 34. As mentioned, the food chute 12 is preferably centrally located along the axis of rotation of the grating disc 34 and the diameter of the grating disc 34 is at least as large as the outer diameter of the food chute 12.

The filter 38 and grating disk 34 are preferably sized to fit within the open center of the juice bowl 36 with sufficient clearance so that the filter 38 does not come into contact with the juice bowl 36. At the same time, the clearance between the filter 38 and the juice bowl 36 is preferably small enough to at least inhibit pulp and other foodstuff byproducts from falling therebetween and into the interior of the upper housing 16. The grating disk 34 and filter 38 preferably function to grind, tear, and otherwise cut foodstuff passed through the food chute 12 and separate the juice from the pulp and/or other foodstuff byproducts ground from the foodstuff. The grating disk 34 and filter 38 are preferably permanently attached together, and the grating disk 34 is exposed at an open bottom end of the filter 38.

As shown best in FIG. 4, the grating disk 34 has an upper side 34a provided with a pair of cutters 34b and a plurality of toothed blades 34c. The cutters 34b are generally centrally located on the grating disk 34 and each includes a cutting edge that faces in the rotational direction. Each of the tooth blades 34c has a semi-circular seat section extending slopingly and upwardly to form a triangular tip facing in the rotation direction. As should be understood, however, it is within the spirit and scope of the present disclosure that the cutters 34b and toothed blades 34c be shaped differently or be configured differently on the grating disk 34. The toothed blades 34c function to grind and tear foodstuff inserted within the juice extractor 10 when the grating disk 34 is rotated during normal operation of the juice extractor 10, thereby enabling juice to be extracted from the foodstuff, as described in more detail below.

The filter 38 and the grating disk 34 are operatively attached to a motor 50, e.g., fixed to an end of an output shaft 50a of the motor 50, in a manner well known in the art, such that rotation of the output shaft 50a causes rotation of the filter 38 and the grating disk 34. Preferably, the motor 50 is a generally conventional electric motor, e.g., an 1100 Watt motor, located within the motor housing 14 and a portion of the upper housing 16, although it is within the spirit and scope of the present disclosure that another type of motor may be used within the juice extractor 10, provided the motor is capable of functioning as described herein. The motor 50 is electrically connected to the switch 22, which acts to selectively power the motor 50 with activation of the switch 22, described above. It should be evident to one of ordinary skill in the art that, when the juice extractor 10 is assembled, powering of the motor 50 causes rotation of the output shaft 50a, which, in turn, causes rotation of the filter 38 and grating disc 34 engaged therewith.

As shown, the juice extractor 10 preferably includes a wire arm 40 pivotably attached to the front and rear faces of the upper housing 16. The wire arm 40 is pivotable about an axis of rotation (not shown) extending between the front and rear ends of the motor housing 14 between an engaged position (FIG. 1) and a disengaged position (not shown). In the engaged position, the wire arm 40 is engaged with a pair of opposed generally arcuate ramps 42 projecting upwardly from the lid 28, so that the lid 28 is held onto the upper housing 16. The ramps 42 include respective bump stops 42a at an upper end thereof, for supporting the wire arm 40 in the engaged position.

When in the engaged position, the ramps 42 axially elevate the wire arm 40 (not shown) along the axis of rotation thereof. The axial elevation of the wire arm 40 in the engaged position causes the wire arm 40 to engage and close a microswitch (not shown) within the motor housing 14. The microswitch is electrically connected in series between the power source of the juice extractor 10 and the switch 22 or the motor 50 and, therefore, is required to be in the closed position in order for power to flow to the motor 50 to operate. When the wire arm 40 is in the disengaged position, the wire arm 40 is in an axially depressed position, wherein the wire arm 40 does not engage the microswitch, thereby leaving the microswitch in a default open position to effectively prohibit the powering of the motor 50. In this manner, the wire arm 40 provides a safety feature of the juice extractor 10 by inhibiting the powering of the motor 50 when the lid 28 is not properly seated upon the upper housing 16 and the wire arm 40 is not in the upward engaged position.

In use, the juice extractor 10 is fully assembled by a user, as shown in FIG. 1. The juice extractor 10 is then plugged into a conventional wall outlet or otherwise connected to a power source. Depending on the size of the foodstuff being inserted, either the first food pusher 30 is removed from within the food chute 12 (for larger foodstuff) or the second food pusher 32 is removed from the bore 30c of the first food pusher 30 (for smaller foodstuff). The wire arm 40 must be in the engaged position, to electrically connect the power source with the switch 22 and motor 50. The switch 22 is then set to the appropriate ON setting (high or low speed) and foodstuff is placed within the food chute 12 or the bore 30c, so that the foodstuff comes into contact with the grating disk 34 within the juice extractor 10. A user urges the foodstuff toward the grating disk 34 via the first food pusher 30 or the second food pusher 32.

The grating disk 34, rotated by the motor 50, grinds away pieces of the foodstuff through interaction of the cutters 34b and toothed blades 34c of the grating disk 34 with the foodstuff. In doing so, pieces of the foodstuff and juice extracted therefrom are forced outwardly against the filter 38 by rotation of the filter 38. The juice passes through the filter 38 and into the juice bowl 36 to flow out of the juice bowl 36 through the spout 18 while the pieces of foodstuff are retained within the filter 38. Due to the shape of the filter 38 and the rotation thereof, the pieces of foodstuff are forced upwardly with respect to the filter 38 and at least some of the pieces of foodstuff are forced up and over the filter 38 into the pulp bin 24. The juice flowing through the spout 18 is preferably collected by the pitcher 20.

There is an improvement, due to the combination of the increased diameter and length of the food chute 12, that multiple smaller diameter foodstuff, e.g., carrots, can be passed therethrough at the same time. Also, larger foodstuff, e.g., an apple or multiple apples, can be passed through the food chute 12 generally without having to chop up the apples or other larger foodstuff before passing them through the food chute 12. Once one batch of foodstuff is passed through the juice extractor 10, the first food pusher 30 or the second food pusher 32 can be removed to enable the user to process additional foodstuff in the manner described above. Operation of the food chute is simplified as the food chute is free of an interlock mechanism.

Once a sufficient amount of foodstuff has been passed through the juice extractor 10, the switch 22 is flipped to the OFF position and the juice extractor 10 can be disassembled for cleaning the components thereof. Preferably, the upper housing 16, juice bowl 36, grating disc 34, filter 38 and pulp bin 24 can be cleaned either by hand or with a dishwasher.

It will be appreciated by those skilled in the art that changes could be made to the embodiments described above without departing from the broad inventive concept thereof. It is understood, therefore, that this disclosure is not limited to the particular embodiments disclosed, but it is intended to include modifications within the spirit and scope of the disclosure.

We claim:

1. A juice extractor comprising:
a housing;
a lid for covering the housing and enclosing an interior thereof;
a generally cylindrical food chute projecting into the housing through the lid, the food chute defining an unrestricted interior channel from an open upper end thereof to an open base end thereof for receiving and passing foodstuff therethrough, the food chute defining an internal diameter of at least approximately three and a half inches and a length from the open upper end to the open base end of at least approximately eight inches, the food chute being free of an interlock mechanism;
a rotatable grating disk proximate the base end of the food chute, rotatable about a substantially vertical axis for grinding the foodstuff advanced through the food chute;
a filter surrounding an outer periphery of the grating disk; for permitting juice extracted from the foodstuff to flow therethrough, and retaining a remainder of the foodstuff; and
a food pusher slidably receivable within the interior channel of the food chute, the food pusher being movable between a disengaged position, wherein the food pusher is not engaged with the food chute and the interior channel remains unrestricted and continuously open between the open upper end and the open base end, and an engaged position, wherein the food pusher is slidably received within the interior channel.

2. The juice extractor of claim 1, wherein the grating disk has a diameter at least substantially equal to an outer diameter of the food chute and an axial center of the food chute is generally in registry with an axial center of the grating disk.

3. The juice extractor of claim 1, wherein the filter is a frustoconically shaped filter attached to the outer periphery of the grating disk and projecting upwardly and outwardly therefrom.

4. The juice extractor of claim 1, further comprising a motor within the housing for rotating the grating disk, an arm, pivotably attached to the housing, and a ramp projecting from the lid, the arm being pivotable relative to the housing and the lid between an engaged position, wherein the arm is engaged with the ramp, and a disengaged position, wherein the arm is disengaged from the ramp, the engagement of the arm with the ramp in the engaged position raising the arm into a position electrically connecting a power source and the motor, to, in turn, power the motor.

5. The juice extractor of claim 4, wherein the arm is a wire arm pivotably attached to front and rear faces of the housing, and the ramp is an arcuate ramp defining a bump stop at an upper end thereof for supporting the wire arm in the engaged position.
